(19) United States
(12) Patent Application Publication
(10) Pub. No.: US 2014/0156472 A1
(43) Pub. Date: Jun. 5, 2014

(54) Logistics and Supply Chain Tracking and Management via Mobile Device

(71) Applicant: Sky Socket, LLC, Atlanta, GA (US)

(72) Inventors: Erich Stuntebeck, Marietta, GA (US); Christian Blake Sorensen, Atlanta, GA (US); Kar-Fai Tse, Peachtree Corners, GA (US); John DiRico, Atlanta, GA (US)

(21) Appl. No.: 13/909,179

(22) Filed: Jun. 4, 2013

(51) Int. Cl. G06Q 10/08

(52) U.S. Cl. CPC G06Q 10/087
USPC 705/28

(57) ABSTRACT

Logistics and supply chain tracking and management via mobile devices may be provided. Data about a plurality of inventory items may be collected via a networked device. Upon receiving an order for at least one of the plurality of inventory items, an instruction associated with fulfillment of the order may be created and performed.

### BACKGROUND

Efficient management of logistics and supply chains require companies to maintain accurate records regarding the amounts and location of innumerable types and pieces of inventory. Conventional approaches utilize Electronic Data Interchange (EDI), a machine-to-machine communication of strictly formatted messages that represent documents and/or other physical items. Even the most efficient EDI environments still require human user intervention, however, such as when instructions to move physical items from one location to another are generated or an error occurs. In such cases, the human user needs the ability to quickly locate the physical items, verify inventory counts, identify the most efficient transport routes, confirm delivery points, etc.

### SUMMARY

This Summary is provided to introduce a selection of concepts in a simplified form that are further described below in the Detailed Description. This Summary is not intended to identify key features or essential features of the claimed subject matter, nor is this Summary intended to be used to limit the claimed subject matter's scope.

Logistics and supply chain tracking and management via mobile devices may be provided. Data about a plurality of inventory items may be collected via a networked device. Upon receiving an order for at least one of the plurality of inventory items, an instruction associated with fulfillment of the order may be created and performed.

It is to be understood that both the foregoing general description and the following detailed description are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the detailed description.

### BRIEF DESCRIPTION OF THE DRAWINGS

Many aspects of the present disclosure can be better understood with reference to the following diagrams. The drawings are not necessarily to scale. Instead, emphasis is placed upon clearly illustrating certain features of the disclosure. Moreover, in the drawings, like reference numerals designate corresponding parts throughout the several views. In the drawings:

FIG. 1 is a block diagram of a user device;

FIG. 2 is a block diagram of an operating environment;

FIG. 3 is a block diagram illustrating a supply chain environment; and

FIG. 4 is a flow chart illustrating a method for providing logistics and supply chain management via mobile devices.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

An environment of interoperating sensors, indicators, and devices may be provided to aid users in performing various tasks associated with logistics and supply chain management. In a large warehouse, vast amounts of inventory may be stored. For example, a distributor of office equipment may have a wide range of products such as furniture, decor, printers, computers, phones, cabling, paper, pens, etc. There may be further divisions and subdivisions within each of these categories. For example, furniture may include multiple types of chairs and cubicle walls, paper supplies may include sticky notes, legal pads, printer paper, notebooks, and computers may include different manufacturer brands and different configurations within each of those brands, etc.

A competitive advantage in logistics and supply chain management arises from the efficiency and speed with which physical products may be located and distributed to a requestor, such as a customer. The faster a particular product can be located within a warehouse and prepared for shipping, the faster a next order can be prepared. Thus, faster distribution of inventory leads to more inventory being delivered in a given period.

Continuous monitoring of the location of each piece of inventory allows for ongoing tracking of the inventory as well as the efficient preparation of orders related to that inventory. The use of barcodes is known in this field, but such usage requires the individual scanning of each barcode to identify a particular piece of inventory. Embodiments consistent with this disclosure may still utilize barcodes for interoperability with existing technologies, but also contemplated is the use of an inventory tracking tag that incorporates a transceiver and indicator. For example, a radio frequency identifier (RFID) tag may be coupled with an audible alarm and/or a visual indicator such as a light emitting diode (LED). Similar tags may make use of many other communication technologies, such as near-field communications (NFC), Bluetooth®/Bluetooth® Low Energy (BLE), wireless (802.11) networking, radio band transceivers, cellular networks, graphene coatings and/or modulators, etc.

Furthermore, human users involved with the logistics and/or supply chain management may play a role via the mobile devices they carry. Assignments may be distributed to the users based on characteristics of their devices, such as location. For example, a user in a warehouse may be given an assignment to retrieve a piece of inventory stored in a nearby location to the user. For another example, a courier may be given routing instructions based on their proximity to a pickup and/or delivery location.

Logistical assignments may also be based on correlations between multiple users. When an order for a piece of inventory, which may be stored at multiple warehouse locations, is received, user locations may be correlated with delivery schedules in order to provide the quickest and/or most cost-efficient routing of the inventory to the ordering customer.

User devices may provide additional functionality that may be of use in the logistical pipeline. For example, a device's camera may be used to take a picture of a pallet of inventory that may then be used to estimate the contents of the pallet. These estimates may be correlated across multiple users and known storage quantities, for example, to estimate how much inventory is in transit relative to being in storage. Similarly the device may read identifier tags associated with the inventory to provide an exact count of inventory on a given pallet and/or shelf.

The technical effects of some embodiments of this disclosure may include establishing control of access to networks and resources when access lists may not be predefined, and reducing and/or eliminating the burden of predefining access lists to control access to networks and resources. Moreover, the technical effects of some embodiments may include enhancing network access control by assigning specific access rights based on access lists to client devices authorized to access associated network beacons and resources.

To reduce the cost of ownership of user devices and cellular and/or data service charges associated with use of such user devices, a business may implement a “bring your own device” (BYOD) policy to allow an employee to use his/her personal device to access business resources rather than provide the employee with a business owned user device for such purpose. To support such a BYOD policy, a user device administrator (i.e. IT administrator) may manage a group of personally owned user devices, via a management application executed by a management server in communication with the user devices over a network, to provide the user devices with secure access to business resources.

The user device administrator may enroll user devices into the management system to monitor the user devices for security vulnerabilities and to configure the user devices for secure access to business resources. The user device administrator may create and/or configure at least one configuration profile via a user interface provided by the management system. A configuration profile may comprise a set of instructions and/or settings that configure the operations and/or functions of a user device, which may ensure the security of the accessed resources. The user device administrator may, for instance, configure a business email configuration profile by specifying the network address and access credentials of a business email account that the users of the user devices are authorized to access. Other configuration policies may include, but are not limited to, hardware, software, application, function, cellular, text message, and data use restrictions, which may be based at least in part on the current time and/or location of the restricted user device. The user device administrator may thereafter deploy the configuration profiles to specific user devices, such as to groups of user devices of employees with similar roles, privileges and/or titles.

The user devices may also have access to personal configuration profiles that may be created by the users of the user devices. The user devices may, for instance, have access to a personal email configuration profile that was created by a user of the user device to provide access to her personal email account. Thus, a user device enrolled in a BYOD management system may have more than one configuration profile for a given use of the user device, such as a personal email configuration profile and a business email configuration profile that are both used for accessing email accounts on the user device.

The user devices may be instructed to enable and/or disable certain configuration profiles according to authorization rights specified by the user device administrator, such as location and/or time-based authorization rights. For example, a BYOD policy may specify that user devices enrolled in the BYOD management system are authorized for personal use outside of the workday and are authorized for business use during the workday. Similarly, a BYOD device may be restricted to business uses while in work locations and/or prohibited from accessing business resources while outside of secure work locations. To implement such a policy, a user device administrator may instruct the user devices to toggle between personal configuration policies and business configuration policies based on factors such as the current time and/or location associated with the user device. The current time may be based on the current time at the current location of the user device, which may be determined by GPS, Wi-Fi, Cellular Triangulation, etc., or may be based on the current time at a configured primary location associated with the user device, which may be the primary office location of an employee user of the user device. As an example, time-based configuration profile toggling may be provided by instructing a user device to enable business configuration profiles and disable personal configuration profiles while the current time is between 9 AM and 5 PM at the current location of the user device, and to disable business configuration profiles and enable personal configuration profiles while the current time is between 5 PM and 9 AM at the current location of the user device.

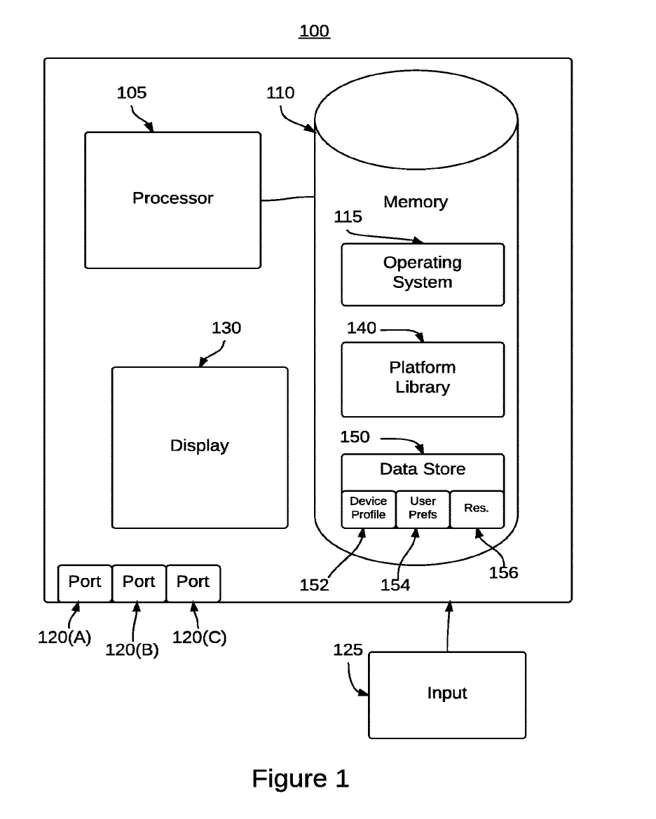

FIG. 1 is a block diagram of a user device 100 comprising a processor 105 and a memory 110. Depending on the configuration and type of device, memory 110 may comprise, but is not limited to, volatile (e.g. random access memory (RAM)), non-volatile (e.g. read-only memory (ROM)), flash memory, or any combination. Memory 110 may store executable programs and related data components of various applications and modules for execution by user device 100. Memory 110 may be coupled to processor 105 for storing configuration data and operational parameters, such as commands that are recognized by processor 105.

Basic functionality of user device 100 may be provided by an operating system 115 contained in memory 100. One or more programmed software applications may be executed by utilizing the computing resources in user device 100. Applications stored in memory 110 may be executed by processor 105 (e.g., a central processing unit or digital signal processor) under the auspices of operating system 115. For example, processor 105 may be configured to execute applications such as web browsing applications, email applications, instant messaging applications, and/or other applications capable of receiving and/or providing data.

Data provided as input to and generated as output from the application(s) may be stored in memory 110 and read by processor 105 from memory 110 as needed during the course of application program execution. Input data may be data stored in memory 110 by a secondary application or other source, either internal or external to user device 100, or possibly anticipated by the application and thus created with the application program at the time it was generated as a software application program. Data may be received via any of a plurality of communication ports 120(A)-(C) of user device 100. Communication ports 120(A)-(C) may allow user device 100 to communicate with other devices, and may comprise components such as an Ethernet network adapter, a modem, and/or a wireless network connectivity interface. For example, the wireless network connectivity interface may comprise one and/or more of a PCI (Peripheral Component Interconnect) card, USB (Universal Serial Bus) interface, PCMCIA (Personal Computer Memory Card International Association) card, SDIO (Secure Digital Input-Output) card, NewCard, Cardbus, a modem, a wireless radio transceiver, a Near-Field Communication (NFC) transceiver, a Bluetooth® transceiver, an RFID transceiver, and/or the like.

User device 100 may also receive data as user input via an input component 125, such as a keyboard, a mouse, a pen, a stylus, a sound input device, a touch input device, a capture device, etc. A capture device may be operative to record user(s) and capture spoken words, motions and/or gestures, such as with a camera and/or microphone. The capture device may comprise any speech and/or motion detection device capable of detecting the speech and/or actions of the user(s).

Data generated by applications may be stored in memory 110 by the processor 105 during the course of application program execution. Data may be provided to the user during application program execution by means of a display 130. Consistent with embodiments of this disclosure, display 130 may comprise an integrated display screen and/or an output port coupled to an external display screen.

Memory 110 may also comprise a platform library 140. Platform library 140 may comprise a collection of functionality useful to multiple applications, such as may be provided by an application programming interface (API) to a software development kit (SDK). These utilities may be accessed by applications as necessary so that each application does not have to contain these utilities thus allowing for memory consumption savings and a consistent user interface.

Furthermore, embodiments of this disclosure may be practiced in conjunction with a graphics library, other operating systems, or any other application program and is not limited to any particular application or system. The devices described with respect to the Figures may have additional features or functionality. For example, user device 100 may also include additional data storage devices (removable and/or non-removable) such as, for example, magnetic disks, optical disks, or tape (not shown).

User device 100 may comprise a desktop computer, a laptop computer, a personal digital assistant, a cellular telephone, a set-top box, a music player, a web pad, a tablet computer system, a game console, and/or another device with like capability.

User device 100 may store in a data store 150 a device profile 152 and a user profile 154. Device profile 152 may comprise, for example, an indication of the current position of user device 100 and/or indications of the hardware, software, and security attributes, which describe user device 100. For instance, device profile 152 may represent hardware specifications of user device 100, version and configuration information of various software program and hardware components installed on user device 100, data transmission protocols enabled on user device 100, version and usage information of various resources stored on user device 100, and/or any other attributes associated with the state of user device 100. The device profile 152 may further comprise data indicating a date of last virus scan of user device 100, a date of last access by an IT representative, a date of last service by the IT representative, and/or any other data indicating maintenance and usage of user device 100. Furthermore, the device profile 152 may comprise indications of the past behavior of associated users, such as resources accessed, charges for resource accesses, and the inventory accessed from such resources. The device profile 152 may also comprise device identifiers that may uniquely identify the user device 100. In some embodiments, the device identifiers may be a unique hardware identifier such as a GUID (Globally Unique Identifier), UUID (Universally Unique Identifier), UDID (Unique Device Identifier), serial number, IMEI (Internationally Mobile Equipment Identity), Wi-Fi MAC (Media Access Control) address, Bluetooth MAC address, a CPU ID, and/or the like, or any combination of two or more such hardware identifiers. In some embodiments, the device identifier may be a unique software identifier such a token or certificate, based at least in part on the aforementioned unique hardware identifiers.

User profile 154 may comprise one or more user identifiers that uniquely identify the user of the user device 100 and/or a listing of factors that may affect the experience of the user. In some embodiments, the user identifiers may include a username, a password, and/or biometric data related to facial recognition, retina recognition, fingerprint recognition, and the like. The user preferences may comprise indications of the user's age, gender, bodily traits, preferred resource types, preferred venue resources, and combinations thereof.

User device 100 may also store at least one resource 156 in the data store 150. Resources 156, for instance, may include any electronic data, such as databases, applications, text files, word processor files, spreadsheet files, presentation files, graphic files, audio files, photographic files, video files, applications and application files, and/or the like. More specifically, resources 156 may include at least one of the following file types: data files, audio files, video files, three-dimensional image files, raster image files, vector image files, page layout files, spreadsheet files, database files, executable files, CAD files, web files, plug-in files, font files, system files, settings files, encoded files, compressed files, disk image files, developer files, backup files, and/or any other files.

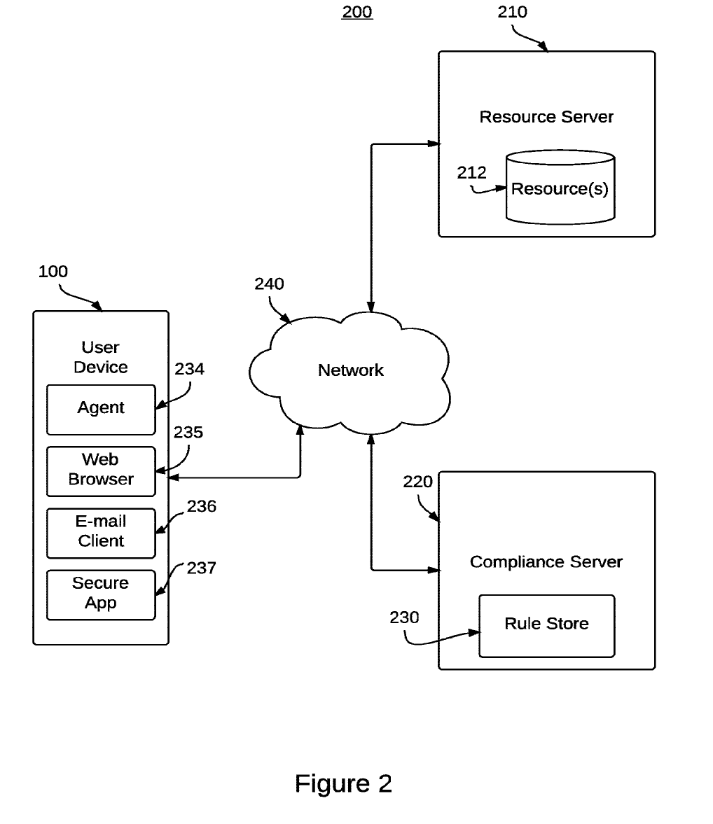

FIG. 2 is a block diagram view of an operating environment 200 comprising user device 100 in communication with a resource server 210, which may provide one or more resource(s) 215, and a compliance server 220, which may provide a management application 230, via a network 240. User device 100, resource server 210, and/or compliance server 220 may be operative to communicate with a plurality of filter proxy services 250(A)-(C) via network 240. In some embodiments, management application 230 and/or filter proxy services 250(A)-(C) may be operative to execute on user device 100 and/or resource server 210.

The compliance server 220 may comprise, for example, cloud-based solutions, server computers and/or any other system providing device management capability. For purposes of convenience, the compliance server 220 is referred to herein in the singular, although it is understood that a plurality of servers may be employed in the arrangements as descried herein. Furthermore, in some embodiments, multiple compliance servers 220 may operate on the same server computer. The components executed on the compliance server 220, for example, may comprise various applications, services, processes, systems, engines, or functionality not disclosed in detail herein.

The compliance server 220 may comprise management application 230 comprising a plurality of compliance rules and/or policies that may be applicable to user device 100. While the management application 230 is shown as within the compliance server 220, the management application 230 may alternately be within the user device 100 and/or remotely located on the resource server 210 and may be remotely updated periodically by compliance server 220 according to common over-the-air (OTA) updating methods. Attempts by user device 100 to perform certain functionality on user device 100 may require user device 100 to be in compliance with one and/or more of the compliance policies/rules. Depending on the sensitivity of a given functionality, different compliance rules may be necessary to ensure that the functionality is adequately restricted. Some functionality may only require ensuring that the proper user is requesting the functionality. Other resources may require compliance with more stringent authorization rules, such as determining whether the functionality is restricted during certain time windows. Accordingly, user device 100 and/or compliance server 220 may be operative to determine whether the user of user device 100 is authorized to perform requested functionality at the time the user requests to perform such functionality.

Compliance server 220 may use the compliance rules to impose hardware restrictions regarding the use of specific wireless devices and specific wireless device features, such as, for instance, cameras, Bluetooth, IRDA, tethering, external storage, a mobile access point, and/or other hardware restrictions. The compliance rules may also impose software restrictions such as the use of specific wireless device operating systems or applications, internet browser restrictions, screen capture functionality, and/or other software restrictions. Mobile device management restrictions included in the compliance rules may comprise encryption requirements, firmware versions, remote lock and wipe functionalities, logging and reporting features, GPS tracking, and/or other mobile device management features.

The compliance server 220 may determine whether the device characteristics of a requesting device (e.g. user device 100) satisfy one or more of the restrictions enumerated in the compliance rules. For example, the compliance server 220 may determine that a requesting device that has a camera, Bluetooth capability, and is executing a specified version of an operating system is compliant with the compliance rules. As another example, the compliance server 220 may determine that a requesting device that is associated with an external storage unit and has screen capture functionality enabled is not compliant with the compliance rules.

In some embodiments, an agent application 234 executed on user device 100 may make the compliance determination based on the device profile, credentials, and/or user preferences. For instance, the agent application 234 may monitor calls by applications, such as a client application 235, and/or a secure application 236, on user device 100 to the operating system 115 of user device 100 to determine whether user device 100 seeks to perform functionality associated with one and/or more of the compliance rules described above. Additionally, the agent application 234 on user device 100 may approve and/or deny the associated functionality requests. For instance, the agent application 234 may instruct operating system 115 on user device 100 to disable the camera of user device 100 in response to a determination that a compliance rule specifies that the camera cannot be used at the time of the request by the user device 100 to operate the camera.

In some embodiments, the agent application 234 executed on user device 100 may rely on compliance server 220 to determine whether a given functionality request on user device 100 is permitted according to the compliance rules. For instance, the agent application may transmit a functionality request, a device profile, credentials, and/or user preferences to compliance server 220 so that compliance server 220 may determine whether user device 100 seeks to perform functionality that may violate a given compliance rule. Additionally, compliance server 220 may approve and/or deny the associated functionality requests. For instance, compliance server 220 may instruct the agent application 234 on user device 100 to instruct operating system 115 to activate a VPN security profile prior to opening a document and/or link.

In some embodiments, the compliance rules may comprise device settings and/or executable instructions that define which functionality the operating system 115 of user device 100 is authorized to perform. Furthermore, the compliance rules may comprise a list of functions, such as those provided by APIs associated with operating system 115 and/or platform library 140, that may be treated as protected functions. Calls to these functions, such as calls to retrieve login credentials, may result in checks by user device 100 and/or compliance server 220 for compliance with the compliance rules.

In some embodiments, the agent 234 may perform a set of ordered operations to accomplish a requested function. These operation sets may be defined by the user device 100 and/or compliance server 220 and may comprise one and/or more operations to determine whether the user device 100 is in compliance with policies from policy store 230. The agent 234 may control at least one respective computing resource of the user device 100. The operations may include configuring at least one respective computing resource of the user device 100 such as restricting access to at least one resource managed by the agent 234.

The Network 240 may comprise, for example, any type of wired and/or wireless network such as a wireless local area network (WLAN), a wireless wide area network (WWAN), Ethernet, fiber-optic network, and/or any other type of wired and/or wireless network now known or later developed. Additionally, the Network 240 may be or include the Internet, intranets, extranets, microwave networks, satellite communications, cellular systems, PCS, infrared communications, global area networks, or other suitable networks, etc., or any combination of such networks.

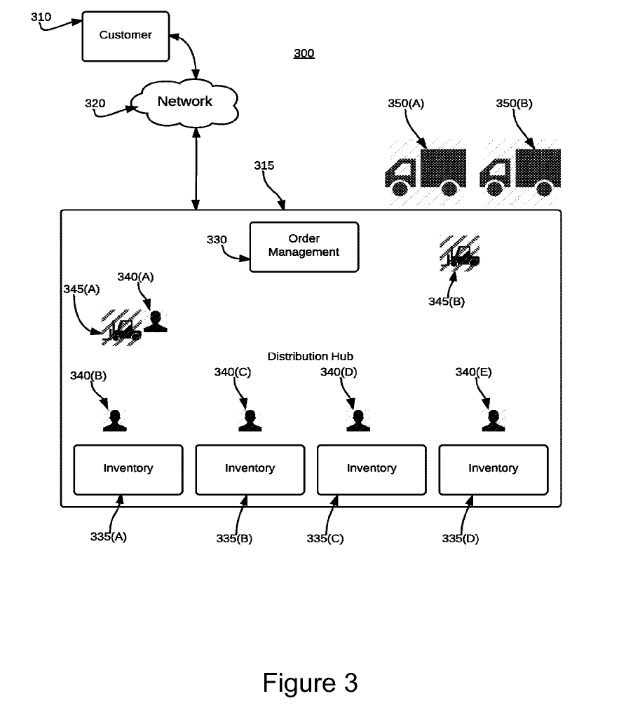

FIG. 3 illustrates a supply chain environment 300 for describing example use cases consistent with embodiments of this disclosure. In supply chain environment 300, a customer 310 may communicate with a distribution hub 315 via an order network 320. Distribution hub 315 may comprise an order management server 330, a plurality of inventory storage locations 335(A)-(D), a plurality of users 340(A)-(E), a plurality of inventory movement equipment 345(A)-(B) (e.g., forklifts, pallet jacks, carts, boxes, cases, trolleys, hand trucks, etc.), and a plurality of delivery vehicles 350(A)-(B).

In some embodiments consistent with this disclosure, customer 310 may submit an order for an item of inventory to a supplier associated with a plurality of distribution centers, such as distribution hub 315, via order network 320. Order network 320 may comprise a dedicated channel of communication between customer 310 and the supplier and/or may comprise a publicly accessible network such as the Internet. The order may be transmitted directly to order management server 330 at distribution hub 315 and/or may be relayed/staged through other devices (not shown), such as intermediate order processing and/or payment servers.

Order management server 330 may maintain a database of information such as the amounts and locations of inventory in the plurality of inventory storage locations 335(A)-(D), the location within distribution hub 315 of each of the plurality of users 340(A)-(E), and the locations and scheduled of each of the plurality of inventory movement equipment 345(A)-(B) and/or the plurality of delivery vehicles 350(A)-(B). The database may be maintained via communication with mobile devices situated with each of the plurality of users 340(A)-(E). Such communication may occur at configurable times, such as on-demand, periodic, and/or continuously updating and may use any of a plurality of communications media, such as order network 320, a cellular network, Bluetooth®, radio (including RFID), near-field communications, and/or any other type of wired and/or wireless communication connection.

The mobile devices associated with the plurality of users 340(A)-(E) may comprise personally owned and/or enterprise-owned devices. These mobile devices may comprise instances of a user device 100 as described above with respect to FIG. 1. The mobile devices may be enrolled in a mobile device management program such as may be provided utilizing compliance server 220. In some embodiments, the mobile devices may comprise commonly available consumer devices, task-specific, and/or industry-specific devices. In some embodiments, multiple devices may be coupled together and associated with a single user. For example, a user device 100 may be coupled to a QR code reader and/or a mailing label printer. The mobile devices may collect information in cooperation with fixed devices, such as bar code readers and/or RFID sensors associated with the plurality of inventory storage locations 335(A)-(D), the plurality of inventory movement equipment 345(A)-(B) and/or the plurality of delivery vehicles 350(A)-(B).

The database of information maintained by order management server 330 may comprise data such as inventory stock levels, locations, delivery schedules, incoming and outgoing orders (e.g., incoming orders from customers and outgoing orders for restocking). The database may further comprise data about the plurality of users 340(A)-E), such as work schedules, skills (e.g., Commercial Drivers License, forklift certifications, safety expertise, etc.), and locations within distribution hub 315.

Order management server may receive data in the form of a picture of a pallet of inventory loaded on inventory movement equipment 345(A) (e.g., a forklift). The picture may be captured by a device associated with inventory movement equipment 345(A), such as a camera mounted to the forklift, and/or a user device 100 associated with user 340(A). Similarly, data about the pallet of inventory may be received by sensors that determine the quantity, type, and location of the inventory loaded on inventory movement equipment 345(A) from transponders, barcodes, QR codes, and/or other indicia associated with the inventory.

Order management server 330 may be operative to transmit instructions to the plurality of users 340(A)-(E) and/or to inventory movement equipment 345(A)-(B), which may comprise user-operated equipment (e.g., forklifts) and/or automated equipment (e.g., robotic loaders). Such instructions may comprise pickup/dropoff instructions for particular inventory and/or routing instructions through distribution hub 315.

In some embodiments, order management server 330 may be operative to facilitate the storage of restocking inventory and/or the transport for delivery of ordered inventory. For example, delivery vehicle 350(A) may deliver inventory for restocking distribution hub 315. Order management server 330 may dispatch inventory movement equipment 345(B) to unload delivery vehicle 350(A) with instructions for efficient routing and deposit of the newly arrived inventory. For example, high turnover inventory may be situated at ground level and/or closer to a delivery vehicle loading dock while low-turnover inventory may be situated further away (e.g., on another floor, a higher shelf, a more distant inventory location, etc.)

When a customer order is received at order management server 330, the database may be used to identify the most efficient way to deliver the ordered inventory. For example, a customer may order a computer with a particular configuration of hardware and software. Order management server 330 may identify the location of the best matching inventory, where the best match may comprise multiple business analytics factors such as taking account of first-in-first-out inventory practices, profit margins, and closest match to the requested configuration. If the best-matching inventory is stored at inventory storage location 335(C), for example, order management server 330 may transmit instructions to a device associated with user 340(D), as the closest user, to pick up the ordered inventory and prepare it for delivery. Order management server 330 may take account of the user's particular skills (e.g., an IT administrator may need to pick up an ordered computer to verify that the computer is working) and/or particular requirements of the ordered inventory (e.g., the ordered inventory is heavy enough to require a pallet jack) when dispatching the instructions.

Order management server 330 may compute efficient pickup and delivery paths for plurality of users 340(A)-(E) based on individual, streams, and/or batches of orders. As orders are received, updated instructions may be transmitted to the users 340(A)-(E) working in distribution hub 315. For example, a user 340(D) loading one computer from inventory location 335(C) may receive updated instructions to load two additional computers for another customer.

In some embodiments, a customer's priority may be taken into account when dispatching instructions. For example, a favored customer and/or a high profit order may result in instructions being transmitted to one and/or more of plurality of users 340(A)-(E) to redirect their efforts to fulfillment of that order before resuming fulfillment of another order they had in progress. Other considerations of providing the instructions may comprise whether a particular instance of inventory movement equipment 345(A)-(B) is full and/or whether it would be faster to unload inventory movement equipment 345(A)-(B) at its delivery destination (e.g., one of delivery vehicles 350(A)-(B) and/or one of inventory storage locations 335(A)-D) prior to picking up a next piece of inventory for transport.

In some embodiments, inventory storage locations 335(A)-(D) may be operative to provide an indication to help identify a particular piece of inventory. For example, as user 340(D) approaches inventory storage location 335(C), the user device 100 associated with 340(D) may communicate with a device associated with inventory storage location 335(C). The communication may identify user 340(D), a target inventory item for user 340(D), and/or the user device 100 associated with user 340(D). The device associated with inventory storage location 335(C) may then indicate which piece of inventory comprises the target inventory item, such as by activating a light on a shelf and/or package associated with the inventory item. Other indicators may be provided by the user device 100, such as audio cues that increase in amplitude and/or frequency and/or change tones as the user 340(D) nears the target inventory item, voice guidance to aid the user 340(D) in locating the target inventory item, and/or displaying, on user device 100, a barcode, picture and/or other identifier associated with the target inventory item.

In some embodiments, devices associated with delivery vehicles 350(A)-(B) may be used to track shipments outside of distribution hub 315. For example, a user device 100 associated with a driver of delivery vehicle 350(A) may receive a manifest and/or may register inventory items that are loaded onto delivery vehicle 350(A). A delivery route may be established for delivery vehicle 350(A), for example, by order management server 330. The progress of delivery vehicle 350(A) may be tracked via location services (e.g., global positioning system) associated with delivery vehicle 350(A), some and/or all of the inventory items loaded on delivery vehicle 350(A), and/or user device 100 associated with the driver of delivery vehicle 350(A). These location services may be used to provide updates on estimated delivery times of the loaded inventory items and/or tracking of lost, missing, and/or stolen items. For example, each driver of a delivery vehicle may carry a mobile device operative to automatically scan for inventory tracking identifiers such as RFID tags. When an item of inventory is reported as stolen, the detection of an identifier associated with the stolen item by any of the drivers and/or other users may trigger a notification to the user associated with the device, to the distribution company, to the ordering customer, to the police, etc.

The devices associated with delivery of items may be used to confirm delivery. For example, a smartphone may be used to capture a digital signature of a person accepting delivery and take a photo of the person and/or their identification. This confirmation may be uploaded automatically and associated with the customer's order for later review. Delivery and/or pickup of some items may require that a person have an appropriate license (e.g., a firearms shipping license) and/or be over a certain age (e.g., over 21 to accept delivery of alcohol). In such cases, the mobile device may capture an image of the appropriate identification and verify that requirements associated with the order are satisfied, such as by confirming a license's validity with an issuing authority or reading the date of birth on a driver's license.

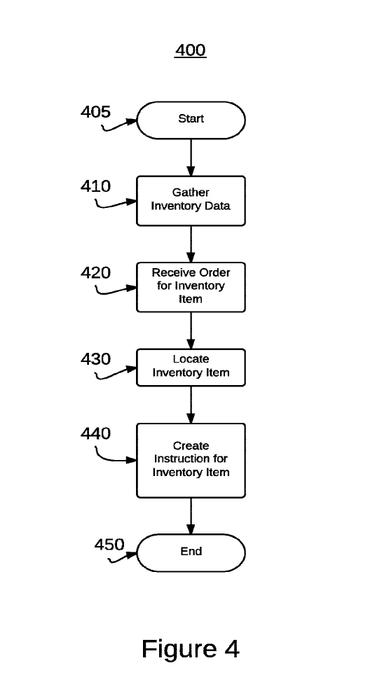

FIG. 4 is a flow chart setting forth the general stages involved in a method 400 consistent with embodiments of this disclosure for providing secure application leveraging of a filter proxy service. Method 400 may be implemented using elements of operating environment 200 and/or supply chain environment 300 as described above. For convenience, method 400 is described below as being performed by an instance of user device 100. This is intended as a non-limiting example, as any and/or all stages of method 400 may be performed by any of the components of operating environment 200 and/or supply chain environment 300. Ways to implement the stages of method 400 will be described in greater detail below. Method 400 may begin at starting block 405 and proceed to stage 410 where user device 100 may gather inventory data. For example, a mobile device associated with a warehouse worker may be used to scan, identify, count, and/or locate units of inventory within the warehouse. Such information gathering may occur passively, without intervention of the user (e.g., receiving and processing RFID signals), and/or actively, at the request of the user (e.g., scanning bar codes and/or taking pictures with the device.)

Method 400 may then advance to stage 420 where user device 100 may receive an order for an item(s) of inventory. For example, customer 310 may order a computer with a particular configuration of hardware and/or software. This order may be sent to order management server 330 for processing and fulfillment.

Method 400 may then advance to stage 430 where user device 100 may locate the inventory item(s) in the order. For example, order management server 330 may use the gathered inventory data to determine where, within order distribution hub 315, the item(s) from the order are stored. The gathered data may, in some embodiments, be updated and/or verified upon receipt of the order to ensure the item(s) are still in the identified location. In some embodiments, the order management server 330 may initiate a search for the item(s) by communicating with devices throughout order distribution hub 315 that may be operable to identify specific item(s) of inventory. If the items are not stored within order distribution hub 315, such as when the item is out-of-stock, the order management server 330 may take action to re-route the order to another distribution hub that has the item(s) in stock, re-order the item(s), and/or notify the customer.

Method 400 may then advance to stage 440 where user device 100 may create an instruction associated with the ordered inventory item. For example, order management server 330 may transmit a pickup or delivery instruction to a mobile device associated with a forklift operator to retrieve or drop-off the ordered inventory item at a given location. Such an instruction may comprise, for example, a description of the item(s) and/or turn-by-turn directions to a pickup/delivery location. Such directions may be optimized for efficient collection/distribution of inventory item(s) associated with multiple orders and/or to route in such a way to avoid traffic congestion. The directions may be applicable both to delivery vehicles 350(A)-(B) outside order distribution hub 315 and/or to inventory movement equipment 345(A)-(B).

In some embodiments, the instruction may comprise a priority for the order. For example, if a new order comes in for whom an existing order is already being prepared for shipment, the order may be given a higher priority to allow for the newly ordered item to be included in the shipment. Similarly, if a delivery vehicle is preparing to leave when a new order comes in for a customer on and/or efficiently convenient to that vehicle's expected route, the new order may be prioritized to allow for inclusion on that vehicle. Prioritization may also apply to inventory storage locations. For example, if a new order comes in for an item of inventory stored at or near a currently loading forklift or other inventory movement vehicle, the new order may be prioritized so that the item can be loaded while the forklift is already in position to do so. Method 400 may then end at stage 450.

An embodiment consistent with the disclosure may comprise a system for providing secure application leveraging of a filter proxy service. The system may comprise a memory storage and a processing unit coupled to the memory storage. The processing unit may be operative to collect a plurality of data about a plurality of inventory items via at least one networked device, receive an order for at least one of the plurality of inventory items, create an instruction associated with fulfillment of the order, and cause the instruction associated with fulfillment of the order to be performed.

Another embodiment consistent with the disclosure may comprise a system for providing secure application leveraging of a filter proxy service. The system may comprise a memory storage and a processing unit coupled to the memory storage. The processing unit may be operative to identify a plurality of inventory items associated with a location, receive an instruction associated with an order, determine whether the instruction is associated with at least one of the plurality of inventory items, and in response to determining that the instruction is associated with the at least one of the plurality of inventory items, cause the instruction to be performed.

Yet another embodiment consistent with the disclosure may comprise a system for providing secure application leveraging of a filter proxy service. The system may comprise a memory storage and a processing unit coupled to the memory storage. The processing unit may be operative to receive a plurality of inventory data from a plurality of mobile devices, receive an order for at least one inventory item, analyze the plurality of inventory data according to the order for the at least one inventory item, and transmit an instruction associated with the order for the at least one inventory item according to the analyzed plurality of inventory data to at least one of the plurality of mobile devices.

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of this disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. The Figures above and their associated descriptions provide a discussion of a variety of operating environments in which embodiments of this disclosure may be practiced. However, the devices and systems illustrated and discussed with respect to the Figures are for purposes of example and illustration and are not limiting of a vast number of computing device configurations that may be utilized for practicing embodiments of this disclosure as described herein.

The term computer readable media as used herein may include computer storage media. Computer storage media may include volatile and nonvolatile, removable and non-removable media implemented in any method or technology for storage of information, such as computer readable instructions, data structures, program modules, or other data. System memory, removable storage, and non-removable storage are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

A number of applications and data files may be used to perform processes and/or methods as described above. The aforementioned processes are examples, and a processing unit may perform other processes. Other programming modules that may be used in accordance with embodiments of this disclosure may include electronic mail, calendar, and contacts applications, data processing applications, word processing applications, spreadsheet applications, database applications, slide presentation applications, drawing or computer-aided application programs, etc.

Generally, consistent with embodiments of this disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of this disclosure may also be practiced in distributed computing environments where tasks are performed by remote processing devices that are linked through a communications network. In a distributed computing environment, program modules may be located in both local and remote memory storage devices.

Furthermore, embodiments of this disclosure may be practiced in an electrical circuit comprising discrete electronic elements, packaged or integrated electronic chips containing logic gates, a circuit utilizing a microprocessor, or on a single chip containing electronic elements or microprocessors. Embodiments of this disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of this disclosure may, for example, be implemented as a computer process and/or method, a computing system, an apparatus, device, or appliance, and/or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of this disclosure may be practiced via a system-on-a-chip (SOC) where each and/or many of the elements described above may be integrated onto a single integrated circuit. Such an SOC device may include one or more processing units, graphics units, communications units, system virtualization units and various application functionalities, all of which may be integrated (or “burned”) onto the chip substrate as a single integrated circuit. When operating via an SOC, the functionality, described herein, with respect to training and/or interacting with any element may operate via application-specific logic integrated with other components of the computing device/system on the single integrated circuit (chip).

Embodiments of this disclosure are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in any code included herein are vested in and the property of the Assignee. The Assignee retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
collecting a plurality of data about a plurality of inventory items via at least one networked device;
receiving an order for at least one of the plurality of inventory items;
creating an instruction associated with fulfillment of the order; and
causing the instruction associated with fulfillment of the order to be performed.

2. The method of claim 1, wherein the at least one networked device comprises a mobile device.

3. The method of claim 2, wherein collecting the plurality of data via the at least one networked device comprises receiving data from a sensor associated with the mobile device.

4. The method of claim 2, wherein the mobile device is associated with a user.

5. The method of claim 2, wherein the mobile device is associated with a vehicle.

6. The method of claim 5, wherein the vehicle comprises a delivery vehicle.

7. The method of claim 5, wherein the vehicle comprises an inventory movement vehicle.

8. The method of claim 1, wherein the instruction comprises a pickup location associated with at least one of the plurality of inventory items.

9. The method of claim 1, wherein the instruction comprises a delivery location associated with at least one of the plurality of inventory items.

10. The method of claim 1, wherein causing the instruction associated with fulfillment of the order to be performed comprises transmitting the instruction to the at least one networked device.

11. An apparatus comprising:
a memory storage; and
a processor coupled to the memory storage, wherein the processor is configured to:
identify a plurality of inventory items associated with a location,
receive an instruction associated with an order,
determine whether the instruction is associated with at least one of the plurality of inventory items, and
in response to determining that the instruction is associated with the at least one of the plurality of inventory items, cause the instruction to be performed.

12. The apparatus of claim 11, wherein the instruction comprises at least one of the following: respond to the received instruction, display the received instruction, relay the received instruction, identify the at least one of the plurality of inventory items, and ignore the received instruction.

13. The apparatus of claim 11, wherein the processor is further configured to:
determine whether the instruction is intended for the apparatus; and
in response to determining that the instruction is intended for the apparatus, confirm receipt of the instruction.

14. The apparatus of claim 11, wherein the processor is further configured to:
determine whether the instruction is intended for the apparatus; and
in response to determining that the instruction is not intended for the apparatus, ignore the instruction.

15. The apparatus of claim 11, wherein the processor is further configured to:
receive a plurality of instructions associated with a plurality of orders; and
prioritize the plurality of instructions.

16. A computer-readable medium which stores a set of instructions that when executed performs a method executed by the set of instructions comprising:
receiving a plurality of inventory data from a plurality of mobile devices;
receiving an order for at least one inventory item;
analyzing the plurality of inventory data according to the order for the at least one inventory item; and
transmitting an instruction associated with the order for the at least one inventory item according to the analyzed plurality of inventory data to at least one of the plurality of mobile devices.

17. The computer-readable medium of claim 16, wherein the instruction comprises a pickup instruction.

18. The computer-readable medium of claim 16, wherein the instruction comprises a delivery instruction.

19. The computer-readable medium of claim 16, wherein analyzing the plurality of inventory data comprises identifying a location of the at least one inventory item.

20. The computer-readable medium of claim 16, further comprising transmitting the instruction associated with the order for the at least one inventory item to the at least one of the plurality of mobile devices nearest to the location of the at least one inventory item.
